(19) United States
(12) Patent Application Publication
(10) Pub. No.: US 2019/0016893 A1
(43) Pub. Date: Jan. 17, 2019

(54) Polymer Modified Natural Asphalts (PMNAs) are formed by using polymers to polymerize the bitumen in the many natural asphalts which are available worldwide, resulting in PMNAs which do not flow or coalesce, perform better than PMBs, and better than refined asphalts or gilsonites used as a modifier of refinery bitumen. These natural asphalts include those found in Trinidad, Venezuela and Iraq, the gilsonites available in the USA, Iran, and China, together with all other natural asphalts

(71) Applicant: Anand Mungalsingh, Maraval (TT)

(72) Inventor: Anand Mungalsingh, Maraval (TT)

(21) Appl. No.: 15/646,749

(22) Filed: Jul. 11, 2017

(51) Int. Cl. C08L 95/00

(52) U.S. Cl. CPC C08L 95/00; C08L 2555/80

(57) ABSTRACT

Some natural asphalts deposits, like those in Trinidad, Venezuela and Iraq, are thermoplastic in nature. After removing the water content, the resulting refined asphalt flows, coalesces, and its mineral matter sediments when blended with refinery bitumen. Packaged in 250 kg coated kegs and barrels, specialized road-paving plants are required for use. On the other hand, gilsonites, also a natural asphalts, are used-friendly, but performs unsatisfactorily compared with refined asphalts as a modifier of refinery bitumen for road-paving. Furthermore, refinery bitumen has been polymerized with polymers for decades. This polymerization of bitumen is used in this patent—the bitumen in these natural asphalts are polymerized with polymers to produce PMNAs which are user-friendly (discrete elements do not flow or coalesce), could be packaged in powders or pellets, could be used with conventional road-paving equipment so there is no need for specialized equipment, and saving costs to the end-user.

Polymer Modified Natural Asphalts (PMNAs) are formed by using polymers to polymerize the bitumen in the many natural asphalts which are available worldwide, resulting in PMNAs which do not flow or coalesce, perform better than PMBs, and better than refined asphalts or gilsonites used as a modifier of refinery bitumen. These natural asphalts include those found in Trinidad, Venezuela and Iraq, the gilsonites available in the USA, Iran, and China, together with all other natural asphalts.

### CROSS-REFERENCE TO RELATED APPLICATIONS

Not Applicable.

### BACKGROUND OF THE INVENTION

This patent deals with all of the forms of natural asphalts available worldwide, i.e. the natural bitumen-based asphalts which are available worldwide.

1. Introduction:

(a) Thermoplastic Asphalts.

These natural asphalts are found at La Brea, Trinidad, West Indies, or at Guanoco Lake, Sucre State, Venezuela, or at Abu Jir, City of Hit, Iraq, or elsewhere worldwide. These asphalts consist of bitumen, mineral matters (including silica, alumina, ferric oxide, etc.) and water, are thermoplastic in nature, acting as both a solid and a liquid at room temperature (the higher the room temperature, the faster the thermoplastic asphalt flows). The discrete elements of these thermoplastic asphalts also easily coalesce.

In this patent, these natural asphalts are termed as ‘thermoplastic’ asphalts.

To use these thermoplastic asphalts, the water-content is firstly removed by boiling the material, removing the water as steam, so that the resulting asphalts would be void of water. These asphalts are known as refined asphalts, and this is the form most widely used worldwide. The main use of refined asphalts is as modifiers of refinery bitumen, producing premium road-paving mixes.

However, refined asphalts also suffer from the flowing and coalescing problems of the thermoplastic asphalts.

Refined asphalts have a number of other uses including as a base for industrial coatings and epoxies, as a base for tires for motor cars, as an adhesive, and as an additive for skin care, etc.

As a result of these flowing and coalescing problems, these refined asphalts have always been packaged throughout the decades in either silicone-coated hardboard kegs, or wooden barrels coated with releasing agents, each keg carrying 250 kg of refined asphalt.

This processing and packaging of thermoplastic asphalts have continued for over a century, and this continues today.

The Compositions of two more commonly-used thermoplastic asphalts (by weight) are:

At La Brea, Trinidad: Water: 30%, bitumen: 40%, mineral matter: 30%.
At Guanoco, Venezuela: Water: 15%, bitumen: 77%, mineral matter: 8%.

The composition of the thermoplastic asphalt in Trinidad's deposit is of the same composition throughout the deposit, whereas the composition of the thermoplastic asphalt in Venezuela's deposit varies slightly throughout the deposit—i.e. the more fluid the material, the higher the bitumen-content.

Therefore not only could the composition throughout the same deposit vary, but the composition from deposit to deposit also vary.

The Chemistry of two more commonly-used refined asphalts (by weight) are:
At La Brea, Trinidad: Bitumen: 54%, mineral matter: 46%.
   The softening point: 101° C.
At Guanoco, Venezuela: Bitumen: 91%, mineral matter: 9%.
   The softening point: 106° C.

(b) Gilsonites.

These natural asphalts are normally soft solids which basically consist of bitumen, with a carbon content of usually above 90% by weight. These natural asphalts are almost void of water (i.e. less than 1.5% by weight), are not thermoplastic in nature, and are therefore user-friendly to handle and use. The discrete elements of these natural asphalts do not flow at room temperature, and the discrete elements do not coalesce. These natural asphalts are found in the USA, Iran, China, in South America, and elsewhere, and are known as gilsonites. The compositions of the gilsonites vary from deposit to deposits, and so too do the melting points.

The chemistry of gilsonites usually includes (by weight):

Gilsonite: Bitumen: 90-97%, Mineral matter: 2-9%, Water: 0.5-1.5%
Melting point: a range between 190−250° C.

2. The Clarifications.

(a) These deposits of natural asphalts available worldwide would include thermoplastic asphalts (contains water, are thermoplastic in nature, and the discrete elements flow and coalesce, like those found in Trinidad, Venezuela, and Iraq), gilsonites (contains almost no water, user-friendly soft solids, like those found in USA, Iran, and China), and other natural bitumen-based asphalts, and are not to be confused with the world's many deposits of tar sands, or tar pits. The compositions of natural asphalts are very different from the materials found in tar sands/tar pits-natural asphalts are rich in bitumen (above 50% by weight), whereas the material in tar sands/tar pits are low in bitumen (usually less than 20% by weight, most often significantly lower). Also the uses are very different—natural asphalt are used as a modifier of refinery bitumen for road-paving, as ink, in epoxies etc., whereas the material in the tar sands/tar pits are mined so as to extract the bitumen-content from the sands;

(b) The word ‘asphalt’ in this patent refers to the natural bitumen-based asphalts found worldwide, and do not refer to the asphalt or bitumen processed from crude oil at refineries;

(c) In this patent, ‘thermoplastic asphalt’ is the term used to define all natural asphalts which contain water and are thermoplastic in nature, and ‘refined asphalt’ is the term used to define the material obtained after the water in the thermoplastic asphalts are removed.

Refined asphalts are also thermoplastic in nature;

(d) The term ‘gilsonite’ was firstly used to define the bitumen-based deposits found in Utah, USA. Since then, this term has been used to call other bitumen-based deposits available worldwide, even though some of these are indeed thermoplastic asphalts. This patent deal with all natural bitumen-based asphalts available worldwide i.e. thermoplastic asphalts and gilsonites, whether, in accordance to this patent, some of these deposits may be differently called; and

(e) The term “conventional road-paving plants” in this patent refers to road-paving plants which do not include specialized heated tanks with stirrers to specially handle refined asphalts.

3. The Characteristics of Natural Asphalts.

A. Thermoplastic Asphalts.

Thermoplastic asphalts are thermoplastic in nature (i.e. solids which act like liquids) at room temperature. The higher the temperature, the more fluid the materials are. The discrete elements of the materials are also coalescent (i.e. easily adhere).

Thermoplastic asphalts contain water. This water is removed by “boiling” these asphalts at the temperature of 163° C. or higher, and the ‘dried’ asphalts are known as refined asphalts.

All refined asphalts are also thermoplastic in nature, and the discrete elements easily coalesce.

Throughout the decades, these refined asphalt have been very popular to be used as a modifier of refinery bitumen.

However, the two main problems with refined asphalts are:

(a) Packaging: Due to the thermoplastic nature, the discrete elements of refined asphalts flow, and this problem increases with temperature. The smaller the size of the discrete element, the easier the ability to handle and use the elements i.e. the size of the element affect the handing, but not the shape. Therefore, to minimize this flowing problem, the discrete elements of the refined asphalts could be packaged in the smaller sizes, so that when the small elements flow, the packaging, storing, handling, and usage are still allowed.

However, the bitumen content in the refined asphalts causes the bitumen on the surface of the discrete elements of the refined asphalts to easily coalesce. It is this coalescent problem which prevents refined asphalts from being packaged in paper or plastic or fabric containers, but the natural asphalts are packaged in hardboard kegs coated with silicone, or in wooden barrels coated with a releasing agent, each in bulk-form containing 250 kg of refined asphalt.

This filling process of kegs or barrels is usually done at 163° C., and as there is shrinkage of the refined asphalts on cooling, the kegs or barrels have to be topped-up during a second filling process, thus adding to the refined asphalts' many handling problems.

The keg and wooden barrel containers cause environmental problems when disposed, and are costly to the end-user.

(b) Usage: Refined asphalts have been successfully used as modifiers to significantly improve the performance of refinery bitumen in road-paving mixes for many decades.

The bulk-form of packaging refined asphalts, each weighing 250 kg, cannot be easily transported via the conveyor belt directly to the drum/pug-mill in conventional road-paving plants. If the bulk-form of 250 kg is broken into smaller pieces on-site, these smaller pieces will continue to coalesce. Refined asphalts are therefore difficult to handle. As a result, the refined asphalts must be separately blended with the refinery bitumen in specialized heated tanks with stirrers, and then the blend is stored until being pumped to the drum/pug-mill for mixing with the aggregates.

Furthermore, as the density of the mineral matter in the refined asphalts is higher than the density of refinery bitumen, these mineral matters sediment when the refined asphalt is blended with refinery bitumen. This sedimentation problem do not occur with the other modifiers (like PMBs, etc.). Therefore, specialized heated tanks with stirrers are required to blend the refined asphalt with the refinery bitumen, and these tanks are then used to store the blend until pumped to the drum/pug-mill for mixing with the aggregates. Furthermore, despite the use of these stirrers, sedimentation still continues, and therefore these blends must be used within determined timeframes. These timeframes, usually about four hours, are determined by the grade of the bitumen, the blend (i.e. asphalt to bitumen ratio), and the characteristics of the tanks and stirrers.

For these reasons, refined asphalts have never ever been used with any conventional road-paving plants available worldwide. These specialized equipment are required on every site refined asphalts are used, thus increasing the costs to the end-user.

(c) Processing and using refined asphalt.

Refined asphalts have been processed and used in the following manner throughout the decades:

(i) The thermoplastic asphalt is mined;

(ii) The water in the thermoplastic asphalt is removed using heat (i.e. using high-pressure steam at a temperature of 163° C.). Using an open flame would cause flash problems;

(iii) As the discrete elements flow and coalesce, the thermoplastic asphalt is packaged in silicone-coated hardboard kegs, or in wooden barrels coated with releasing agents;

(iv) As shrinkage occurs on cooling, the kegs or wooden barrels have to be topped-up during a second filling process. Each keg or barrel contains 250 kg of refined asphalt;

(v) The kegs or barrels are broken on-site to access the refined asphalts. This procedure is hazardous, and the keg and barrel containers cause environmental problems on disposal—this disposal is costly; and

(vi) On every site refined asphalt is used, specialized heated tanks with stirrers are required to keep the mineral matter in these refined asphalts in suspension when blended with refinery bitumen, and despite the use of stirrers, these blends must be used within timeframes determined by the grade of bitumen, the type of blend (i.e. asphalt: bitumen ratio), and the characteristics of the tanks and stirrers—this timeframe is usually about four hours.

A flowchart of the production and use of refined asphalt is therefore as follows:

Mining→water removed using steam at 163° C.→filled in coated kegs or wooden barrels→topped up (second filling)→used with specialized heated tanks with stirrers.

The problem therefore is to solve the coalescent problem of the natural or refined asphalts, as the flowing problem could be tolerated with using conveyable discrete elements, and the sedimenting problem would no longer occur as the refined asphalt could be transported directly to the drum/pug-mill in conventional road-paving plants.

The transporting, storing, handling and using of these asphalts in such forms are therefore costly to the end-users.

The above characteristics (and problems) also apply to all thermoplastic natural asphalts (flowing and adhering).

All the above characteristics (and problems) also apply to all refined asphalts.

This patent address the flowing and coalescent problems of these natural asphalts by polymerizing the bitumen in the natural asphalts with polymers, resulting in products whose discrete elements do not flow, do not coalesce, could be packed in paper or plastic or fabric containers of any sizes usually up to one metric ton, could be used on conventional road-paving material—so the sedimentation problem of the mineral matters in the bitumen no longer exists, and the polymerization of the bitumen in the natural asphalts with polymers results in longer molecule-chains in the polymerized modified natural asphalts, or PMNAs, thereby giving performances which are better than those obtained when the refined asphalts are used as a modifier of refinery bitumen for road-paving.

B. Gilsonites.

Gilsonites have none of the user-unfriendliness of the thermoplastic or refined asphalts.

However, although gilsonites are natural bitumen-based asphalts, and despite the fact that natural asphalts are normally good modifiers of refinery bitumen when used for road-paving, the performances of gilsonites as a road-paving material are significantly lower compared the refined asphalts, the result being caused by the low content of the maltenes in the bitumen of the gilsonites.

This patent therefore address the performance of gilsonites as a road-paving modifier by polymerizing the bitumen in the gilsonite, increasing the percentage of maltenes in the bitumen, improving the road-paving performance as a modifier of refinery bitumen, but still keeping the used-friendliness.

4. The Marketing of Refined Asphalts and Gilsonite as a Road-Paving Modifier.

(a) Refined Asphalts.

Despite all of the above problems, the refined asphalt from Trinidad has been successfully used as a road-paving material since the 1880s. From 1890 to 1969, over twelve million tons of refined asphalt has been used worldwide as a road-paving material, with an average of 143,000 tons/year. A significant part of these sales during the later decades were packaged in coated kegs. The refined asphalt is used as a modifier to enhance the performance of the refinery bitumen when used for road-paving. When refined asphalt is blended with any refinery bitumen, the resulting binder gives superior performance as a road-paving material. For this reason, refined asphalt from Trinidad is known worldwide as one of the premium modifiers available anywhere, having gained decades of goodwill as a successful modifier of refinery bitumen for road-paving. Examples of use could be found on the George Washington Bridge, as well as on the runways at the LaGuardia and JFK Airports in New York City, and at Terminal 3 of the Beijing Capital Airport, which was paved with refined asphalt from Trinidad as a modifier for the 2008 Summer Olympics.

Kegged refined asphalt continues to be produced and marketed today. However, because of the problems detailed, annual volumes after 1969 have significantly reduced.

Further, during the period from 1885 to 1934, over one million tons of thermoplastic asphalt from Venezuela were mined and exported to South Amboy, N.J., USA, where the water in the thermoplastic asphalt was removed, and then the refined asphalt used as a modifier of refinery bitumen, producing road-paving mixes which were used for paving in the east coast of the USA, including the cities like New York, New Jersey, Philadelphia and Washington D.C.

Thermoplastic asphalt from Venezuela has not been mined since 1934, and that despite the fact that this natural asphalt is a premium modifier of refinery bitumen when used for road-paving.

Iraqi thermoplastic asphalt is very rich in bitumen, and after refined, are also used as a modifier of refinery bitumen for road-paving. Significant volumes are mined, mainly for export.

Refined asphalts have decades of goodwill of successfully modifying refinery bitumen, increasing the performance of the mixes. Therefore the performances of refined asphalts over the decades are the standards to be achieved by all the PMNAs produced by this patent.

(b) Gilsonites.

These forms of gilsonites have been used in the middle-East during the middle ages.

USA Gilsonites were first mined in the 1880's. Since then, the USA gilsonite's market has grown throughout the decades, mainly used as ink, as a base in paints, for water-proofing, and as an adhesive, etc. However, gilsonite has never really been used as a modifier of refinery bitumen for road-paving mixes, as the low content of the maltene in USA gilsonite give unsatisfactory road-paving performances when compared with refined asphalts.

Whilst 82,000 metric tons of USA gilsonite was used in 2014, not much was used in the road-paving industry, the reason being already stated.

Significant volumes of gilsonites are mined in Iran for export.

Small volumes of gilsonites are also mined in China and in South America, and elsewhere, and some of these are used as a modifier of refinery bitumen with lower performances compared with refined asphalts.

5. Attempts to produce pelletized refined asphalt with the thermoplastic asphalt from La Brea, Trinidad.

There have been attempts (by others) to form pellets from the thermoplastic asphalt from Trinidad. In one attempt, the water-content of the thermoplastic asphalt is first removed (Section 3 Item 3A(c) to form the molten refined asphalt. Pellets are then formed with the molten refined asphalts using a pelletized machine, cooling the pellets under water, and these are then coated with a powder (which could be as much of 9% of the total weight) to cover the pellets so that coalescing would not occur. The pellets are then packaged in fabric containers. This process does not change the refined asphalt characteristics of flowing and coalescing, and the mineral matter in the refined asphalt still sediments. However, by using small pellets, the flowing problem with refined asphalt from Trinidad is minimized so that the refined asphalt could be handled and used. The coalescent problem is solved by coating the pellets of the refined asphalt with the powder. Finally, by conveying the pellets of the refined asphalt directly to the drum/pug-mill in conventional road-paving plants, there would be no need to separately blend the refined asphalt with the refinery bitumen, so that the refined asphalts' sedimenting problem would no longer arise.

However, the coalescent problem returns when the powder falls off the pellets during transport, storage and usage. Also the powder used to coat the pellets is used in the final road-paving mix, this powder-coated refined asphalt is not 100% pure refined asphalt.

6. Other Technologies.

(a) Thermoplastic Asphalts and Refined Asphalts Refined asphalts are proven modifiers, increasing the performance of refinery bitumen as a road-paving material for many decades.

However, thermoplastic and refined asphalts have problems of flowing, coalescing (i.e. packaging), and using (i.e. requiring specialized equipment), etc., thus making these asphalts not as cost effective as the other modifiers.

However, most the non-thermoplastic asphalts do not perform as good as the thermoplastic asphalts.

As a result, many attempts have been made to solve the above problems by marrying these thermoplastic asphalts or refined asphalts with additives (like a powder) and/or stabilizers (such as silica) which form part of the final road paving mix, therefore losing the decades of goodwill of successfully using refined asphalts as modifiers for road-paving, and in all cases, the performances with the modifiers have been adversely affected by these additives and stabilizers.

(b) Gilsonites Gilsonites are not really proven modifiers of refinery bitumen because of its low maltene-content.

These gilsonites have performed unsatisfactorily when compared with the refined asphalts as a road-paving modifier of refinery bitumen.

Through the decades, new research with gilsonite has been mainly done on the use of this material as a cement for the mining/drilling industries, and no research has been done to improve the use of gilsonite as a modifier of refinery bitumen for the road-paving industry.

(c) The Use of Stabilizers

There are other technologies which addressed some of the problems detailed in Section 3 Items 3A(a) and (b) above by using thermoplastic asphalts as the starting base (i.e. not starting with the refined asphalt as a base). In these technologies:

(i) Stabilizers (such as clay or silica or others) are mixed with the thermoplastic asphalts using high shear mixers which do not add heat in the action, thereby increasing the melting point of the material;

(ii) Elevated temperatures up to and between 160 and 200° C. are reached during the processing; and

(iii) Other stabilizers are sometimes also used with reactions to increase the surface tension around the pellets of refined asphalt, so that the pellets do not coalesce; and

(iv) The powders and pellets of refined asphalt do not coalesce, are packaged in plastic containers, and could be conveyed directly to the drum/pug-mill in conventional road-paving plants.

However, these stabilizers adversely affect the performance when used as a road-paving modifier.

7. The Solution—The Polymerization of Natural Asphalt.

The bitumen produced from the refineries have been to polymerize with polymers for many decades, significantly improving the performances of road-paving mixes.

This solution uses this known technology of the polymerization of refinery bitumen to further polymerizing the bitumen-content in natural asphalts with polymers, whilst still keeping the mineral matter in the natural asphalts, so producing Polymer Modified Natural Asphalts (PMNAs).

The resulting discrete elements of the PMNAs do not flow, do not coalesce, and could be used on conventional road-paving plants so the sedimentation problems would no longer arise. The road-paving mixes with PMNAs give better performances than mixes produced with refined asphalts and gilsonite.

8. Statement of the Field of Endeavor.

A method using polymers to polymerize the bitumen in natural asphalts, like those found in the deposits at La Brea, Trinidad, West Indies, at Guanoco, Sucre State, Venezuela, at City of Hit, Iraq, or the gilsonites found in the USA, Iran, China, or the other natural bitumen-based asphalts available worldwide, producing powders or pellets which do not coalesce, could be packaged in paper or plastic or fabric containers, could be used with conventional road-paving plants, and the PMNAs perform better that the refined asphalt, and are more cost-effective than the refined asphalts.

### BRIEF SUMMARY OF THE INVENTION

1. Statement of the Object of the Invention.

This invention uses the known technology of the polymerization of refinery bitumen to polymerize the bitumen-content in natural asphalts using polymers, whilst still keeping the mineral matter content in the natural asphalts, producing Polymer Modified Natural Asphalts (PMNAs) which are very user-friendly, and perform better than when the refined asphalts are blended with refinery bitumen for road-paving mixes.

This Section briefly covers the method:
(a) Thermoplastic asphalts:

### Either:

the water-content of the thermoplastic asphalts could be firstly removed as steam by boiling the thermoplastic asphalts at temperatures of 163° C. or above, or by removing the water-content in the discrete elements of these asphalts with hot air, or naturally in the atmosphere, or by other drying methods. The resulting weighed refined asphalts are then mixed with the weighed polymer, and the bitumen in the refined asphalt is polymerized with polymers by boiling the mixture at temperatures of 163° C. or above, stirring the molten mixture with stirrers (or with other stirring methods), or the mix of the refined asphalt and polymers is stirred (or blended, or pulverized, or milled, or other methods which cause the polymerization process), heat may be added at temperatures below the boiling point of 163° C. to improve the polymerization process, or with no heat.

After the polymerization process is completed, the PMNA is tested (see Section Six Item (g) below) to confirm that the process is completed.

After the polymerization process is completed, the PMNA is then formed into powder or pellet form and then packaged.

A flowchart of the production of PMNA is therefore as follows:

Mining→water removed→polymer added to refined asphalt→polymerization by boiling or stirring→powder/pellet formed→packaged.
Or on the other hand:

(ii) The weighed thermoplastic asphalts are then mixed with the weighed polymer, and then the bitumen in the thermoplastic asphalt polymerized with the polymers either with heat at the temperature of 163° C. or higher, the molten mixture is them stirred (or with other stirring methods), and the water-content removed as steam, or using the polymers, the bitumen in the thermoplastic asphalt is polymerized by a method of stirring (or blending, or pulverizing, or milling, or other methods which causes the polymerization process), heat may be added at the temperature below the boiling point of 163° C., or with no heat, and the water content then removed by hot air, or in the atmosphere, or other drying methods.

After the polymerization process is completed, the PMNA is tested (see Section Six Item (g) below) to confirm that the process is complete. The PMNA is then formed into powder or pellet form and then packaged.

A flowchart of the production of PMNA is therefore as follows:

Mining→polymer added to thermoplastic asphalt→polymerization by boiling or stirring→drying by boiling or other drying methods→powder/pellet formed→packaged.

The resulting PMNAs do not flow, the discrete elements do not coalesce, hereby solving the problems associated with the thermoplastic and refined asphalts' flowing and coalescent nature, solving the problems of transporting, storing, handling and using refined asphalts, and are user-friendly and very cost-effective.

The PMNAs could be packaged in paper or plastic or fabric containers, and could be used with conventional road-paving plants. If the plastic used to package the PMNAs, these containers and the PMNA could be sent directly to the drum/pug-mill, as the plastic containers do not adversely affect the performance of the final road-paving mix.

There are no environmental problems with the disposal of the various forms of packaging.

When used with aggregates, the mixes would perform better than with the refined asphalts.

Also, the rate of sedimentation of the mineral matter in the PMNA when blended with refinery bitumen is significantly lower than the rate of sedimentation when the refined asphalts are blended with refinery bitumen, thereby increasing the time-window of the use of the PMNA-refinery bitumen blend significantly higher than the four hours allowed with blends with refined asphalts and refinery bitumen.

These processed asphalts could be used to produce either hot or cold mixes for road-paving.

(b) Gilsonite

Gilsonite is mainly a bitumen, and is almost void of water, so the removal of any water-content do not form part of the polymerization process.

In this process, the gilsonite is first mined, the weighed polymer is then added to the weighed gilsonite and then

either
polymerized by boiling the mixture at a temperature between 190-250° C. (or higher), using stirrers (or other methods to stir/mix/blend/etc),
or
polymerized by stirring/mixing/blending/etc by various methods (like mills, pulverizers, blenders, etc.) so as to cause and/or improve the polymerization process. Heat may be added at temperatures below the boiling point of 190-250° C. to improve the polymerization process, or with no heat.

After the polymerization process is completed, the PMNA is tested (see Section Six Item (g) below) to confirm that the process is complete.

The finished PMNA is then formed into a powder or pellet form, whether by a powder or a pellet equipment, or by other methods.

The powder or pellet is then packaged in paper or plastic or fabric containers of any sizes, usually up to one metric ton.

A flowchart of the production of PMNA is therefore as follows:

Mining→polymer added to gilsonite→polymerization→powder/pellet→packaged.

### BRIEF DESCRIPTION OF THE SEVERAL VIEWS OF THE DRAWING

Not Applicable.

### DETAILED DESCRIPTION OF THE INVENTION

(a) The Natural Asphalts.

The bitumen-content of almost all natural asphalts could be polymerized using polymers. The following is a list of such natural asphalts:

Thermoplastic asphalts like those found in La Brea, Trinidad, or Guanoco, Venezuela, or City of Hit, Iraq, or elsewhere; or
Gilsonite, like those found in Utah, USA, or Kermanshah, Iran, or China, or in South America, and elsewhere; or

All other natural bitumen-based asphalts.

(b) The Polymers to be Used to Polymerize the Bitumen-Content of the Natural Asphalts.

As natural asphalts consist of bitumen, the polymers which are used to polymerize refinery bitumen could be used to polymerize the bitumen in the natural asphalts. The ranges of polymers which could be used to polymerize the bitumen in natural asphalts could include, amongst others: thermoplastics, thermosetting plastics, elastomers, plastomers, fibers, and others. Some of these types would include, amongst others: rubbers, thermoplastic rubbers, and thermoplastic polymers. Two more popular polymers are:

SBS: styrene-butadiene-styrene-copolymer; and

EVA: ethylene-vinyl-acetate copolymer.

Any of the above polymers, or any combinations of the same, could be used to polymerize the bitumen-content of the natural asphalts.

The polymer to be used to polymerize the bitumen in the natural asphalts would be determined by the use of the PMNA, that is, the polymer to be used would be determined by the required design of the final binder, example: the strength of the blinder in different temperature ranges, etc.

(c) The Process.

The process may be batch, or continuous.

Batch: by weight.
Continuous: by rate of flow (weight/time).

(d) The Mixture.

The weight (i.e. batch—example: tons), or the rate of flow (i.e. continuous—example: tons/hour), of the polymer to be used would be determined by the weight of the bitumen in the natural asphalt (i.e. thermoplastic asphalt or gilsonite), or the weight of the bitumen in the refined asphalt, to be polymerized. The polymer could be about 5% of the total weight of the polymer and the bitumen-content of the natural asphalt in the mixture, or about 5% of the total weight of the polymer and the bitumen-content of the refined asphalt in the mixture. As the percentages of the weight of the water-content, and the bitumen-content, in the natural asphalt is known, and as the percentage of the bitumen-content in the refined asphalt is also known, the mixture of the polymer:natural asphalt ratio (by weight), or the mixture of the polymer:refined asphalt ratio (by weight), could be easily determined. The polymer:natural asphalt ratio (by weight), or the polymer:refined asphalt ratio (by weight), must be used to ensure that all the polymer or all the bitumen in the natural asphalt/refined asphalt would be polymerized. The test in Section Six Item (g) below could be used to ensure total polymerization in any mixture.

Furthermore, specific polymers could be used to produce forms of PMNAs with specific design characteristics to handle different conditions, for example, the PMNA could be produced which would overcome high temperature ranges, etc.

As different natural asphalts contain different percentages by weight of bitumen, the percentage by weight of the polymer to be used in batch, or at a specific rate of flow, would be different.

Furthermore, compatibility between the polymer and the bitumen in the natural asphalt is confirmed before attempting to produce a good PMNA.

(e) The Machinery.

Size of mixing tanks—depending on mix size or rate of flow.

Stirrers—could be mills or pulverizers or blenders or mixers, etc., or any combination of the same. The efficiency of the polymerization process would be dependent on the batch size/rate of flow, size and rpm of stirring blades, power of motors, etc.

Pumps—power is determined by the weight of the natural asphalt, or weight of refined asphalt, or the weight of the polymer, or the weight of the mixture (asphalt and polymer), or the rate of flow, or the required polymerization duration, etc.

Drying (i.e. removing water-content)—could be done by ‘boiling’ the thermoplastic asphalts or gilsonite, or dried with hot air, or naturally in the atmosphere, or other drying methods.

Powder/pellets—standard equipment to form powder or pellet. The forming equipment should be able to handle molten (therefore hot) PMNA, or cold (therefore stiff—harder to form) PMNA.

Packaging—standard equipment, paper or plastic or fabric containers, usually up to one metric ton.

(f) The Method

A. The Polymerization of Thermoplastic Asphalts:

Thermoplastic asphalts consists of water, mineral matters and bitumen.

There are two options as to how the bitumen in the natural asphalts could be polymerized with polymers—either the original water-content of the thermoplastic asphalts is firstly removed, and then the bitumen in the thermoplastic asphalts polymerized using polymers, (i.e. the polymerization of the refined asphalts), or the bitumen in the thermoplastic asphalts could be polymerized with original water-content, and this water-content is then removed after the polymerization process is completed.

The two options are:
Drying and then Polymerization:
(i) boil the weighed thermoplastic asphalt at a temperature up to 163° C. (or higher) to remove the water-content as steam, or the water-content in the weighed thermoplastic asphalt is removed by any other methods (like using hot air, or naturally in the atmosphere, or other drying methods). The resulting material is the refined asphalt.
The weighed polymer is then added to the weighed refined asphalt (see Section Six Item (d) above) to the required polymer:refined asphalt ratio.
Then either
the bitumen-content of the refined asphalt is then polymerized using the polymers by boiling the mixture at a temperature up to 163° C. or higher, using stirrers, or the molten mixture is stirred by any other method (like pulverizers, blenders, mills, etc.) so as to cause and/or improve the polymerization process,
or
the mixture of weighed polymer and weighed refined asphalt is stirred or milled or pulverized or blended or any other method to cause and/or improve the polymerization of the bitumen in the refined asphalt, heat may be added at the temperature below the boiling point of 163° C., or with no heat.
After the polymerization process is completed, the PMNA is tested (see Section Six Item (g) below) to confirm that the process is complete.
The PMNA is then formed into a powder or pellet form, whether by a powder or a pellet equipment, or by other methods.
The powder or pellet is then packaged in paper or plastic or fabric containers of any sizes, usually up to one metric ton.
In all options above, the required polymer:refined asphalt ratio by weight is maintained. This is to ensure that the bitumen-content in the refined asphalt is completely polymerized, and that there is no remaining polymer, or no remaining bitumen in the refined asphalt, after the polymerization process is completed.
A flowchart of the production of PMNA is therefore as follows:
Mining→drying→polymerizing→testing→powder/pellet→packaging→used with conventional road-paving equipment.
Polymerization/Drying or Polymerization then Drying:
(ii) the weighted polymer is added to the weighed thermoplastic asphalt (see Section Six Item (d) above).
Then either
the bitumen-content of the thermoplastic asphalt is then polymerized with the polymers by boiling the mixture at a temperature up to 163° C. or higher, using stirrers, or the molten mixture is stirred by any other method (like pulverizers, blenders, mills, etc.) so as to cause and/or improve the polymerization process. During the polymerization process, the water-content of the thermoplastic asphalt is removed as steam.
After the polymerization process is completed, the PMNA is tested (see Section Six Item (g) below) to confirm that the process is complete.
The PMNA is then formed into a powder or pellet form, whether by a powder or a pellet equipment, or by other methods. The PMNA is then packaged.
or
the mixture of weighed polymer and weighed thermoplastic asphalt is stirred or milled or pulverized or blended, or using other methods which cause and/or improve the polymerization of the bitumen-content of the thermoplastic asphalt, heat may be added at the temperature below the boiling point of 163° C., or with no heat.
After the polymerization process is completed, the PMNA (with water-content) is tested (see Section Six Item (g) below) to confirm that the process is complete.
The PNMA (with water-content) is then either formed into powder or pellet forms and the water-content is then remove using hot air, or naturally in the atmosphere, or removed in any other method or the water-content of the PMNA is then removed with hot air, or naturally in the atmosphere, or removed in any other method, and the PMNA is then formed into powder or pellet form.
The powder or pellet is then packaged in paper or plastic or fabric containers of any sizes, usually up to one metric ton.
In all options above, the required polymer:natural asphalt ratio (or polymer:refined asphalt ratio) by weight is maintained. This is to ensure that the bitumen-content of the natural or refined asphalt is completely polymerized, and that there is no remaining polymer, or no remaining bitumen in the thermoplastic asphalt or refined asphalt, after the polymerization process is completed.
A flowchart of the production of PMNA is therefore as follows:
Mining→polymerizing→testing→drying and powder/pellet formed or powder/pellet formed and drying→packaging→used with conventional road-paving equipment.

B. The Polymerization of Gilsonites:

Gilsonite consists mainly of bitumen, and is almost void of water, so the removal of water-content do not form any part of this process, especially the heat used in part of the processes below could easily remove any water-content found in the gilsonite.

The process is as follows:

The weighed polymer is added to the weighed gilsonite.
Then either
the bitumen in the gilsonite polymer is polymerized with the polymers by boiling the mixture at a temperature between 190-250° C. (or higher) using stirrers, or the molten mixture is stirred by any other method (like mills, pulverizers, blenders, etc.) so as to cause and/or improve the polymerization process,
or
the mixture of polymer and gilsonite is stirred or milled or pulverized or blended or using any other methods which cause and/or improve the polymerization of the bitumen-content of the gilsonite, heat may be added at the temperature below the boiling point of between 190-250° C., or with no heat.
In all options above, the required polymer:gilsonite ratio by weight is maintained. This is to ensure that the bitumen-content of the gilsonite is completely polymerized, and that there is no remaining polymer or no remaining bitumen in the gilsonite after the polymerization process is completed.

After the polymerization process is completed, the PMNA is tested (see Section Six Item (g) below) to confirm that the process is complete.

The PMNA is then formed into a powder or pellet form, whether by a powder or a pellet equipment, or by other methods.

The powder or pellet is then packaged in paper or plastic or fabric containers of any sizes, usually up to one metric ton.

A flowchart of the production of PMNA is therefore as follows:

Mining→mixing→polymerizing→powder/pellet→packaging→used with conventional road-paving equipment.

C. PMNAs.

The powders or pellets of PMNAs do not flow or coalesce, and in this form could be conveyed directly to the drum/pug-mill on conventional road-paving plants. If the plastic containers are used to package the PMNA, these containers with the PMNA could be sent directly to the drum/pug-mill, as the plastic containers do not adversely affect the performance of the final road-paving mix.

The performance of PMNA as a modifier of refinery bitumen in a road-paving binder is better than that of refined asphalt, and significantly better than that with gilsonite.

However, whilst the mineral matters in PMNAs obtained from refined asphalt still sediment when blended with refinery bitumen, the sedimentation-rate is significantly lower than the blends of refined asphalt with refinery bitumen.

Also, the sedimentation of the mineral matters in PMNAs produced with gilsonite do not occur.

Significant costs would be saved by the end-user of refined asphalts as PMNAs have no flowing and coalescing problems.

Furthermore, the polymerization of the bitumen-content of gilsonites significantly improves the road-paving performance when these PMNAs are used to modify refinery bitumen.

(g) Quality Control of the Polymerization.

There are many methods which could be used to confirm whether a polymer/bitumen mix has been completely processed. Any of the available methods could be used here.

For example, a ‘stretched-film could be used in the following method:

(i) When the polymerization process is uncompleted: Undissolved (or swollen) particles appear as dark spots on the stretched film with transmitting light.

(ii) When the polymerization process completed: No particles found on the stretched film or in the blend.

(iii) As the particle sizes of the mineral matters in the natural asphalt are all under twenty microns, these mineral matters do not affect this test.

The time required for the completion of the polymerization process would depend on the natural asphalt or the gilsonite or the polymer or the batch size/rate of flow or any of the pieces of machinery, or other.

(h) The Differences and Improvements.

The Methods detailed in this patent are new in that, amongst others:

(i) Section Three Item 3A (c) shows an attempt by others to form pellets which do not coalesce. In this attempt, the water content of the thermoplastic asphalt is removed to form a refined asphalt which is packaged in bulk-form in kegs and barrels, each carrying 250 kg, making it a hazard to handle, an environment problem to discard the containers, and with the same user-unfriendly characteristics (coalescing, cannot be used on conventional equipment, etc.). However, in this patent, the PMNAs are user-friendly (no flowing, no coalescing, used on conventional equipment), are packaged in paper or paper or fabric containers of various sizes (usually up to one metric ton), and easier to handle. The plastics containers, if used, could be thrown with the powder/pellets into the drum/pug-mill in the conventional equipment.

The paper and fabric containers form no environmental problem to discard.

(ii) In this attempt by others (see Section Three Item 5), a covering powder is used to cover the pellets to stop coalescing, and when this powder falls off the pellets during transport, storage or handling, the coalescent problem re-occurs. Furthermore, the powder (about 9% of total weight, or more) used to coat the pellets forms a part of the final road-paving mix, and the powder adversely affect the performance. Also, the powder-coated refined asphalt used is not the same material as refined asphalt, thereby losing the decades of goodwill of refined asphalt as a modifier for road-paving.

(iii) Section Three Item 6(c) shows an attempt by others to use stabilizers (like clay or silica or others) to form pellets of refined asphalt which do not coalesce. However these stabilizers adversely affect the performance of blends of refined asphalts with refinery bitumen.

(iv) The rate of the sedimentation of the mineral matters in the powders and pellets of PMNAs when blended with refinery bitumen is slower than that the corresponding rates of sedimentation with refined asphalt when blended with refinery bitumen.

(v) In order to use with refined asphalts, specialized heated tanks with stirrers are required on-site. However, these pellets and powders of PMNAs could be used on conventional road-paving plants, and require no on-site specialized equipment.

(vi) The PMNAs could be used for non-paving options, like as a base for industrial coatings and epoxies, as a base for motor tires, etc.

(vii) No additives are used in the patent, save and except using polymers to lengthen the chains of the molecules of the bitumen in the natural asphalts by the polymerization of the bitumen.

(viii) This process applies to all natural bitumen-based asphalts.

1-6. (canceled)

7. An asphalt paving composition wherein a natural asphalt and one or more polymers are combined to form a polymerized modified asphalt.
